(19) United States
(12) Patent Application Publication
(10) Pub. No.: US 2015/0074782 A1
(43) Pub. Date: Mar. 12, 2015

(54) SECURE METHOD FOR SSO SUBSCRIBER ACCESSING SERVICE FROM OUTSIDE OF HOME NETWORK

(71) Applicant: NEC Corporation, Tokyo (JP)

(72) Inventors: Xiaowei Zhang, Tokyo (JP); Anand Raghawa Prasad, Tokyo (JP)

(73) Assignee: NEC Corporation, Tokyo (JP)

(21) Appl. No.: 14/395,544

(22) PCT Filed: Apr. 18, 2013
(86) PCT No.: PCT/JP2013/002636

§ 371 Date: Oct. 20, 2014

(30) Foreign Application Priority Data
Apr. 24, 2012 (JP) 2012-098605

(51) Int. Cl. H04L 29/06; H04W 12/06

(52) U.S. Cl. CPC H04L 63/0815; H04W 12/06
USPC 726/8

(57) ABSTRACT

When a UE (10) transits from a home MNO (20) to another network (visited network) (30), the visited network (30) or the UE (10) notifies the home MNO (20) of UE's location. The home MNO (20) validates the UE's authenticity and its location, and sends an assertion to the SP (40) via the visited network (30) or the UE (10). The SP (40) checks the validity of the assertion and starts providing service to the UE (10) via the visited network (30).

### TECHNICAL FIELD

The present invention relates to a mechanism for a Single Sign-On (SSO) service subscriber to continuously access service when it transits out of home Third Generation Partnership Project (3GPP) network domain, which also provides SSO service to the user. The mechanism provides SSO service when user is travelling and enables a transparent and seamless transit while accessing service from service provider (SP). It prevents attacks to user and its subscription in the visited network or by a rouge visited network. The mechanism can also enhance user experience by providing service directly through visited network.

### BACKGROUND ART

Single Sign-On service provides user a new experience of logging-in all the subscribed services by entering the username and password only once. SSO is being studied in Third Generation Partnership Project (3GPP) with the intention to have 3GPP operators as SSO service providers (see NPL 1). One of the solutions envisaged by 3GPP providing mobile operators a part of SSO business is to enable operators to store user SSO credentials that can be used to authenticate users at the time of network authentication. Thus the mobile operator is more than an Identity provider (IdP) but also a SSO service provider. In the same way with normal SSO service scenario, the SSO provider (home 3GPP network) provides an assertion of UE (User Equipment)/user authentication to service provider (SP) such that user is able to access the subscribed service.

It is possible that UE roams/transits to another network from current 3GPP network provisions the envisaged SSO service. The visited network can be a non-3GPP network or 3GPP network which does not provide SSO service. It is expected that UE/user should be able to use the current service without intervention.

### CITATION LIST

### Non Patent Literature

NPL 1: 3GPP TR 22.895, “Study on Service aspects of integration of Single Sign-On (SSO) frameworks with 3GPP operator-controlled resources and mechanisms; (Release 11)”, V1.2.0, 2011-11

### SUMMARY OF INVENTION

### Technical Problem

UE/user accessing from visited network wants to use the service continuously and with the same quality as that in the home network. In the envisaged solution the home 3GPP network stores the SSO credentials of the user thus the following problems arise:

1. For user transited out of its home 3GPP network, home 3GPP network will have to continuously provide SSO service to the user, and it should know and be able to verify the current location of UE.

2. Data for the given service always goes via the home MNO (Mobile Network Operator) while UE is in the visited network. This creates traffic load, and thus pain, for the home MNO and causes poor quality service provided to the user.

3. A new assertion can be requested by SP and home 3GPP network should be able to provide the assertion.

4. User re-authentication can be required by SP while the user is accessing service from outside of home MNO domain. This will require home MNO to be involved in the re-authentication procedure.

### Solution to Problem

An aspect of this invention considers user accessing service from outside of home network. UE/user moves out from its home 3GPP network to a visited network while it is using a service provided by a given SP. The visited network can either be another 3GPP network (support or not support SSO service) or a non-3GPP network.

The UE will send its location information to the home 3GPP network. The home 3GPP network will verify the location information and the authenticity of UE so that based on the validity of them the home 3GPP network can continue providing SSO service. And if the visited network is also capable of providing SSO service and both networks have an agreement, the home 3GPP network can send the assertion to visited network, such that the service can be provided to user via visited network. When a new assertion or user re-authentication is required, home 3GPP network can provide them, if the home 3GPP network and visited network have an agreement. Or, the assertion or proof of user-authentication will have to be sent to UE and redirected to SP.

### Advantageous Effects of Invention

According to the present invention, it is possible to solve the issues mentioned above.

### BRIEF DESCRIPTION OF DRAWINGS

FIG. 1 is a block diagram showing a configuration example of a system according to an exemplary embodiment of the present invention;

FIG. 2 is a sequence diagram showing one example of operation in a system according to an exemplary embodiment of the present invention;

FIG. 3 is a sequence diagram showing another example of operation in a system according to an exemplary embodiment of the present invention;

FIG. 4 is a block diagram showing a configuration example of a UE according to an exemplary embodiment of the present invention;

FIG. 5 is a block diagram showing a configuration example of a node for a home network according to an exemplary embodiment of the present invention; and

FIG. 6 is a block diagram showing a configuration example of a node for a visited network according to an exemplary embodiment of the present invention.

### DESCRIPTION OF EMBODIMENTS

The invention considers the issues mentioned above and more details will be given in this section.

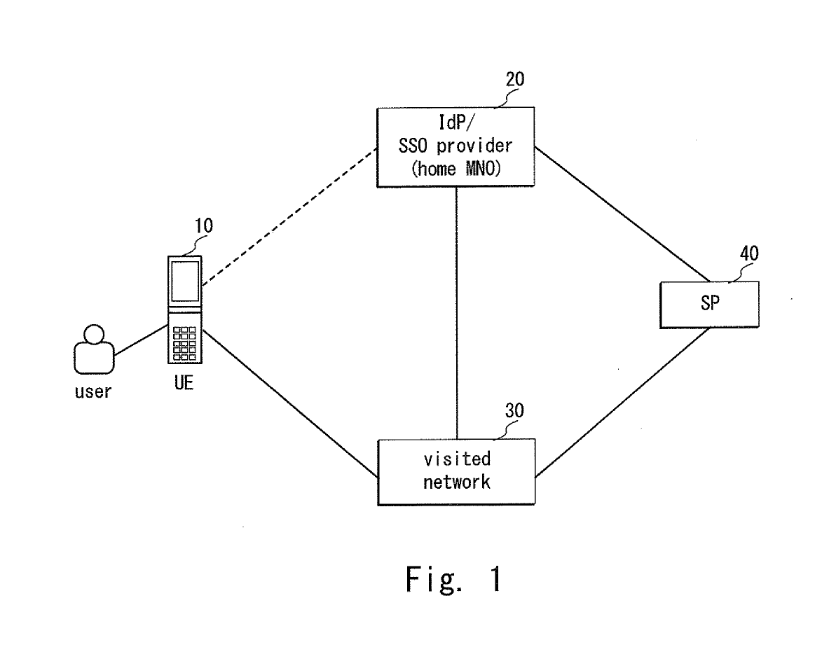

Hereinafter, an exemplary embodiment of the present invention will be described with reference to FIGS. 1 to 6.

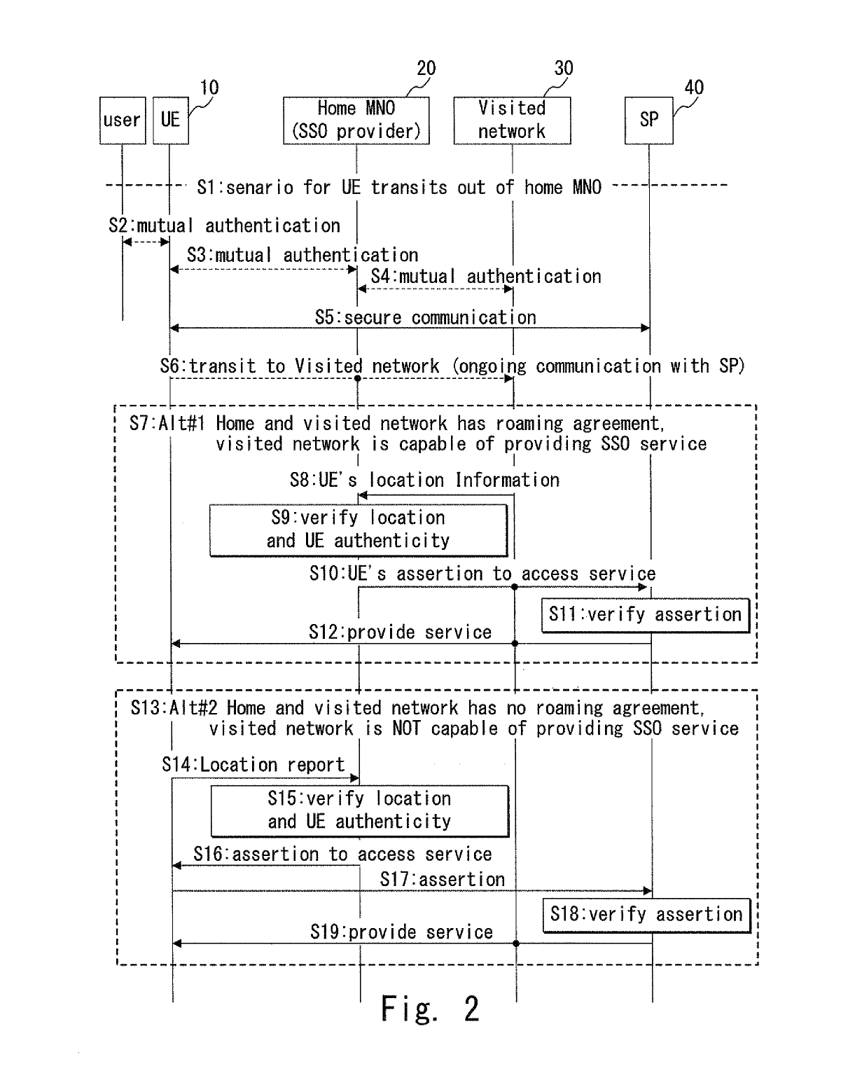

As shown in FIG. 1, a system according to this exemplary embodiment includes a UE 10 used by a user, a home MNO 20 of the UE/user, a visited network 30 to which the UE/user transits, and an SP 40 which provides service to the UE 10/user. The home MNO 20 serves as an IdP and an SSO service provider. Note that as shown in FIG. 2, mutual authentication between the user and the UE 10, mutual authentication between the UE 10 and the home MNO 20, and mutual authentication between the home MNO 20 and the visited network 30 are performed (Steps S2 to S4). Further, secure communication is established between the UE 10 and the SP 40 (Step S5).

A few assumptions are made as below.

1. User subscribes SSO service provided by the home 3GPP operator.

2. Visited network may or may not support SSO service.

3. Visited network can perform mutual authentication with UE.

Taking as the example a scenario where the UE 10 transits out of the home MNO 20 as shown in FIG. 2, operation of this exemplary embodiment will be described.

### 1. Location Information

When the user moves to a new network 30 (Step S6), the home 3GPP operator (1) should know where the UE 10 is, which requires the UE 10 to send current location information securely and (2) must be able to verify that the location information is from the correct UE.

Two different situations are considered as follows.

(1) Home and visited networks 20, 30 have roaming agreement (Step S7):

In this case, the visited network 30 will perform authentication to UE 10 and affirm to the home network 20 that the UE 10 is at its network 30 (Step S8), and the home network 20 can validate the UE's authenticity and its location during authentication (Step S9).

(2) Home network 20 and visited network 30 do not have roaming agreement and different credentials are used in UE authentication at the visited network 30 (or no credential is used in the case of a free WiFi network) (Step S13):

In this case, UE 10 will have to inform its location securely to the home network 20 and prove its authenticity to the home network 20 (Steps S14 and S15).

Solutions are the following (a) or (b) for example.

(a) A shared key between the IdP of the home 3GPP 20 network and UE 10:

This key can be set at the time of service initialization and changed at regular basis by the home 3GPP network 20. The key can be sent securely using the transport security. This key is used by the UE 10 to create an authentication value when it moves to a visited network thus allowing the UE 10 and home 3GPP network 20 to mutually authenticate each other. The key also can be used to protect the location information such that the location will not be exposed to attackers.

(b) A token is sent or created at the UE 10:

Both UE 10 and home 3GPP network 20 use tokens to authenticate each other.

### 2. Service Provision Optimization

In a traditional fashion, the SP will send data to the home 3GPP network as the SP assumes that the home 3GPP network is the UE. The home 3GPP network will forward the traffic to the UE in the visited network. This will cause heavy traffic load to home 3GPP work and poor service access.

To optimize the path of service delivery i.e., delivery of data from SP 40 to the UE 10 directly via the visited network 30 instead of taking the path of home 3GPP network 20, solutions for different situations are given below.

(1) The visited network 30 is capable of the new service:

In this case, assume that the visited network 30 is a 3GPP network and has a roaming agreement with the home 3GPP network 20. The home 3GPP network 20 sends a new assertion to the visited network IdP (SSO service capable) and the visited network 30 forwards the new assertion to the SP 40 (Step S10). The SP 40 will check the validity of the assertion and start sending data to the visited network 30 (Steps S11 and S12).

The assertion provided from visited network 30 to SP 40 can be through a direct communication or the redirection from UE 10 to SP 40.

(2) The visited network 30 is not capable of the new service:

Follow steps given under (1) except that the new assertion is sent to the UE 10 (Steps S16 and S17). In this case, UE will need to be updated.

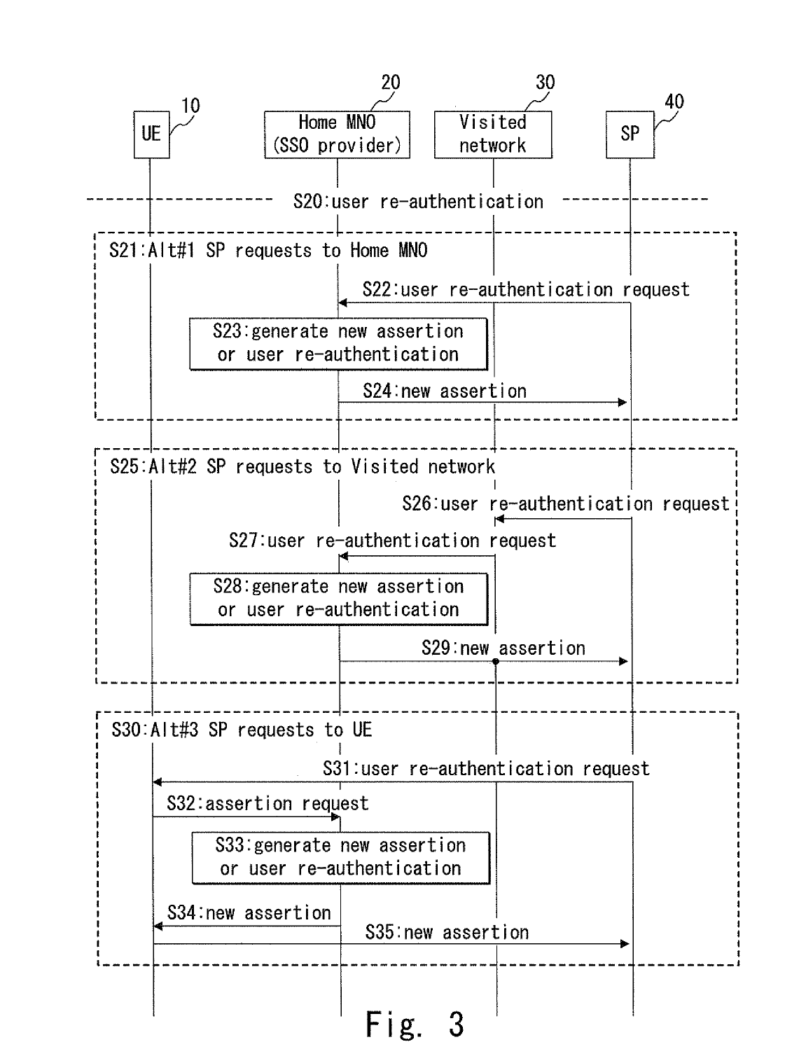

Next, another operation of this exemplary embodiment will be described with reference to FIG. 3.

### 3. New Assertion Provision and User Re-Authentication

The assertion will time-out after sometime or the SP might require user/UE re-authentication before that according to its policy. In this case, the SP will either contact the UE or the home 3GPP network. For the envisaged solution, depending on situations in earlier steps, the UE can be represented by the home 3GPP network, visited network which has the new SSO service or the UE itself.

(1) The SP 40 contacts the home 3GPP network 20 (SSO provider) (Step S22). The home 3GPP network 20 will generate the new assertion or perform user re-authentication (Step S23). The home 3GPP network 20 can either provide the new assertion or user re-authentication proof by direct communication with SP 40 or by traffic optimization as described in previous section (Step S24).

(2) The SP 40 contacts the visited 3GPP network 30 (Step S26). The visited 3GPP network 30 will request the assertion or user re-authentication from the home 3GPP network 20 (Step S27). Depend on if there is an agreement between home and visited network, home 3GPP network 20 can decide whether to send the assertion or proof of user re-authentication to the visited network 30 (Steps S28 and S29).

(3) The SP 40 contacts the UE 10, that UE 10 in turn communicates with the home 3GPP network 20 gets the assertion and informs the SP 40. Traffic flows via the visited network 30 (Steps S31 to S35).

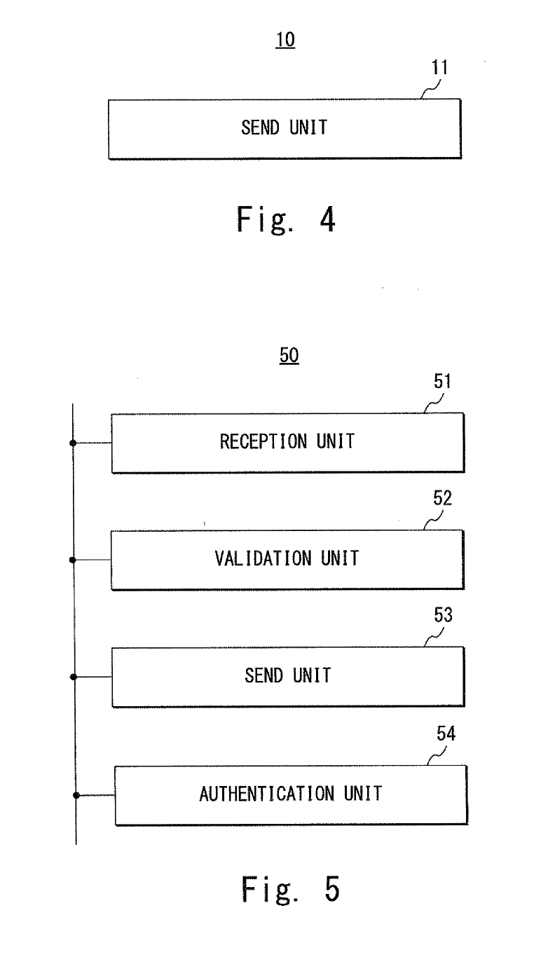

Next, configuration examples of the UE 10, the home network 20 and the visited network 30 according to this exemplary embodiment will be subsequently described with reference to FIGS. 4 to 6.

As shown in FIG. 4, the UE 10 includes a send unit 11. The send unit 11 securely sends the location information to the home network 20 as shown at Step S14 in FIG. 14. This unit 11 can be configured by, for example, a transceiver which conducts radio communication with the home network 20 and the visited network 30, and a controller which controls this transceiver to execute the processes shown in FIGS. 2 and 3, or processes equivalent thereto.

Further, the home network 20 includes a node 50 shown in FIG. 5. The node 50 includes a reception unit 51, a validation unit 52, a send unit 53, and an authentication unit 54. The reception unit 51 receives the location information from the visited network 30 or the UE 10 as shown at Steps S8 and S14 in FIG. 2. The reception unit 51 also receives the user re-authentication request from the SP 40, the visited network 30 or the UE 10 as shown at Steps S22, S27 and S32 in FIG. 3. The validation unit 52 validates authenticity of the UE 10 and the location information as shown at Steps S9 and S15 in FIG. 2. The send unit 53 sends the assertion to the SP 40 through the visited network 30 or the UE 10 as shown at Steps S10, S16 and S17 in FIG. 2. The send unit 53 also re-sends the assertion to the SP 40 in response to the re-authentication request as shown at Steps 23, S24, S28, S29 and S33 to S35 in FIG. 3. The authentication unit 54 re-authenticates the UE 10 in response to the re-authentication request as shown at Steps S23, S28 and S33 in FIG. 3. Note that the units 51 to 54 are mutually connected with each other thorough a bus or the like. These units 51 to 54 can be configured by, for example, a transceiver which conducts radio communication with the UE 10, a transceiver which conducts communication with the visited network 30 and the SP 40, and a controller which controls these transceivers to execute the processes shown in FIGS. 2 and 3, or processes equivalent thereto.

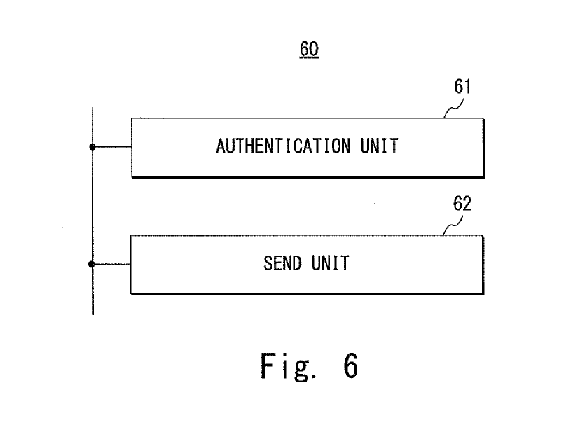

Furthermore, the visited network 30 includes a node 60 shown in FIG. 6. The node 60 includes an authentication unit 61 and a send unit 62. The authentication unit 61 authenticates the UE 10. The send unit 62 sends the location information to the home network 20 as shown at Step S8 in FIG. 2. Note that the units 61 and 62 are mutually connected with each other thorough a bus or the like. These units 61 and 62 can be configured by, for example, a transceiver which conducts radio communication with the UE 10, a transceiver which conducts communication with the home network 20 and the SP 40, and a controller which controls these transceivers to execute the processes shown in FIGS. 2 and 3, or processes equivalent thereto.

Note that the present invention is not limited to the above-mentioned exemplary embodiment, and it is obvious that various modifications can be made by those of ordinary skill in the art based on the recitation of the claims.

This application is based upon and claims the benefit of priority from Japanese patent application No. 2012-098605, filed on Apr. 24, 2012, the disclosure of which is incorporated herein in its entirety by reference.

The whole or part of the exemplary embodiments disclosed above can be described as, but not limited to, the following supplementary notes.

(Supplementary Note 1)

When a SSO subscriber transits to visited network which has roaming agreement with the home network, the visited network performs UE authentication and sends the location information of the UE to the home network. The home network validates the UE's authenticity and its location.

(Supplementary Note 2)

While UE transited to a visited network which has no roaming agreement with home network, shared key between UE and the home network IdP or token created by UE is used for UE securely sending location information to home 3GPP network, and then home network validates UE authenticity.

(Supplementary Note 3)

Home network IdP provides assertion for roaming UE to access service.

(Supplementary Note 4)

A means for SP requesting a new assertion of UE or user re-authentication, which contains three alternatives: contacting home 3GPP network, visited network or UE.

(Supplementary Note 5)

Home 3GPP network performs user re-authentication for UE at visited network.

(Supplementary Note 6)

Home 3GPP network generates new assertion for UE accessing service from visited network.

(Supplementary Note 7)

Traffic optimization by SP delivering service to UE via visited network.

### REFERENCE SIGNS LIST

10 UE
11, 53, 62 SEND UNIT
20 HOME MNO
30 VISITED NETWORK
40 SP
50, 60 NODE
51 RECEPTION UNIT
52 VALIDATION UNIT
54, 61 AUTHENTICATION UNIT

1. A system comprising:
a UE (User Equipment);
a home network of the UE, the home network delivering a service from a service provider to the UE; and
a visited network that has agreement on roaming with the home network,
wherein when the UE transits to the visited network away from the home network while communicating with the service provider, the visited network authenticates the UE and sends location information of the UE to the home network, and
wherein the home network validates, upon receiving the location information, authenticity of the UE and the location information such that the service is continuously provided to the UE.

2. The system according to claim 1, wherein the home network sends, to the service provider through the visited network, an assertion for causing the service provider to provide the service via the visited network without passing through the home network.

3. The system according to claim 2, wherein the home network re-sends the assertion in response to a request from the service provider.

4. The system according to claim 1, wherein the home network re-authenticates the UE in response to a request from the service provider.

5. The system according to claim 3, wherein the home network receives the request directly from the service provider, or through the visited network or the UE.

6-14. (canceled)

15. A node that is placed within a home network of a UE and that delivers a service from a service provider to the UE, the node comprising:
a reception unit that receives, when the UE transits to a visited network that has agreement on roaming with the home network away from the home network while communicating with the service provider, location information of the UE from the visited network; and
a validation unit that validates authenticity of the UE and the location information such that the service is continuously provided to the UE.

16. The node according to claim 15, further comprising:
a send unit that sends, to the service provider through the visited network, an assertion for causing the service provider to provide the service via the visited network without passing through the home network.

17. The node according to claim 16, wherein the send unit is configured to re-send the assertion in response to a request from the service provider.

18. The node according to claim 15, further comprising:
an authentication unit that re-authenticates the UE in response to a request from the service provider.

19. The node according to claim 17, wherein the reception unit is configured to receive the request directly from the service provider, or through the visited network or the UE.

20-27. (canceled)

28. A UE that receives a service delivered by a home network of the UE from a service provider to the UE; the UE comprising:
a send unit that securely sends, when the UE transits to a visited network that has no agreement on roaming with the home network away from the home network while communicating with the service provider, location information of the UE to the home network in order to cause the home network to validate authenticity of the UE and the location information such that the service is continuously provided to the UE.

29. The UE according to claim 28, wherein the send unit is configured to use, for securely sending the location information, a key shared between the UE and the home network, or a token sent to or created at the UE.

30. The UE according to claim 29, wherein the key is shared at a time when the service is started, and changed by the home network on a regular basis.

31. A method of controlling operation in a node that is placed within a home network of a UE and that delivers a service from a service provider to the UE, the method comprising:
receiving, when the UE transits to a visited network that has agreement on roaming with the home network away from the home network while communicating with the service provider, location information of the UE from the visited network; and
validating authenticity of the UE and the location information such that the service is continuously provided to the UE.

32-36. (canceled)
